(19) United States
(12) Patent Application Publication
(10) Pub. No.: US 2025/0265578 A1
(43) Pub. Date: Aug. 21, 2025

(54) A MULTIPLE PAYMENT TOKENIZED DIGITAL TRANSACTION AUTHENTICATION METHOD

(71) Applicant: MASTERCARD INTERNATIONAL INCORPORATED, Purchase, NY (US)

(72) Inventors: Simon Phillips, York (GB); Alan Johnson, Essex (GB)

(21) Appl. No.: 18/857,640

(22) PCT Filed: Mar. 6, 2023
(86) PCT No.: PCT/US2023/014601

§ 371 Date: Oct. 17, 2024

(30) Foreign Application Priority Data
Apr. 21, 2022 (GB) 2205779.8

(51) Int. Cl. G06Q 20/38; G06Q 20/40

(52) U.S. Cl. CPC G06Q 20/38215; G06Q 20/401

(57) ABSTRACT

Following a tokenized consumer-initiated transaction, it is typical for subsequent merchant-initiated transactions to be processed without a cryptogram, causing a real opportunity for fraudulently generated merchant-initiated transactions to be submitted and subsequently processed. The present disclosure provides a method that solves or alleviates this problem. The method comprises: receiving a first transaction request including a payment token, first payment information, a first cryptogram and a next transaction notification identifying a future second transaction; authenticating the first transaction request based at least in part on the first cryptogram; providing an authorization response approval message to authorize the first transaction request; and providing a next transaction cryptogram suitable for use in authenticating a second transaction request.

### CROSS REFERENCE TO RELATED APPLICATION

This application claims the benefit of United Kingdom Patent Application No. 2205779.8, which was filed on Apr. 21, 2022, the entire contents of which are hereby incorporated by reference for all purposes.

### FIELD OF THE DISCLOSURE

The present disclosure relates to a multiple payment tokenized digital transaction authentication method and finds particular, although not exclusive, utility in providing a method of cryptographically securing each payment of a multiple payment.

### BACKGROUND

To protect sensitive payment card data, the data may be replaced with a secure payment token. A payment card may be inserted into a digital wallet, wherein the primary account number, card verification code/value and expiration data is replaced with the payment taken that serves as a secure reference to the payment card. When a consumer makes a purchase with a payment token, it is typically secured using a one-time cryptogram. The cryptogram is typically calculated using a token number of the payment token and payment information, such as the merchant information, payment amount and currency of the purchase. The authorization message submitted to authorize payment to the merchant is termed a consumer-initiated transaction, as the consumer is directly involved in the request. When a digital wallet is used to create the cryptogram, it often brings additional benefits to the merchant such as fraud liability protection due to the cardholder authentication performed and indicated within the cryptogram data.

For ecommerce transactions, merchants or their payment service providers may request a cryptogram from a server-based system instead of a digital wallet. The server-based system will typically be operated by a token service provider that is typically a payment network but may also be a card issuer or third party. During authorization processing, the token service provider receives and validates the cryptogram. The token service provider then forwards the authorization message to the card issuer for financial approval indicating that the cryptogram was valid and the liability position of the issuer when cardholder authentication has been performed.

After the consumer-initiated transaction, a merchant may submit a further authorization message, termed a merchant-initiated transaction, for a further payment related to the original purchase. Merchant-initiated transactions cannot typically benefit from being secured with a cryptogram as the consumer and their digital wallet is not available to generate a cryptogram. Only the digital wallet can create the appropriate cryptogram for that consumer's token.

Although a merchant may request a cryptogram for a merchant-initiated transaction from the token service provider, merchant-initiated transactions are typically permitted to be processed without a cryptogram, causing a real opportunity for fraudulently generated merchant-initiated transactions to be submitted and subsequently processed.

Therefore, it is desirable to provide a transaction authentication method to alleviate at least these problems. Objects and aspects of the present disclosure seek to provide a transaction authentication method to alleviate or solve these problems.

### SUMMARY

According to a first aspect of the present disclosure, there is provided a multiple payment tokenized digital transaction authentication method comprising: receiving a first transaction request including a payment token, first payment information, a first cryptogram and a next transaction notification identifying a future second transaction; authenticating the first transaction request based at least in part on the first cryptogram; providing an authorization response approval message to authorize the first transaction request; and providing a next transaction cryptogram suitable for use in authenticating a second transaction request.

In this way, a second transaction, such as a merchant-initiated transaction following a consumer-initiated transaction, may be cryptographically secured.

The next transaction cryptogram may be stored by a merchant and subsequently used to process a second transaction such as a merchant-initiated transaction. In this way, a merchant need not store a customer's card information, or other such information, to process a further transaction. Accordingly, the risk of fraud is reduced.

Providing a cryptogram for use in the second transaction may mean that further transactions, such as merchant-initiated transactions, without a cryptogram may be refused.

The first cryptogram may be a function of a token number of the payment token and the first payment information. The next transaction cryptogram may be a function of, at least, the token number. Further information may be included as described herein.

The authorization response approval message may comprise the next transaction cryptogram. In this way, the next transaction cryptogram may be provided within the authorization response approval message related to the first transaction. Accordingly, a cryptogram suitable for use in processing a second transaction may automatically be provided following the processing of the first transaction.

The first transaction request may relate to a consumer-initiated transaction. The second transaction may relate to a merchant-initiated transaction. In this way, the merchant-initiated transaction may be cryptographically secured in the same way as the original consumer-initiated transaction. As such, any consumer or merchant protection, such as fraud liability protection, afforded by use of the first cryptogram may apply equally to the next transaction cryptogram.

The first transaction request may include a third transaction notification identifying a future third transaction. The method may further comprise providing a third cryptogram, or a further transaction cryptogram, suitable for use in authenticating a third transaction request. This arrangement may be particularly useful for finance or credit schemes in which a cost is spread over three payments. The authorization response approval message may comprise the third cryptogram. In this way, the third cryptogram may be provided within the authorization response approval message related to the first transaction. Accordingly, a cryptogram suitable for use in processing a third transaction may automatically be provided following the processing of the first transaction. Any other number of cryptograms may be provided in this way.

The method may further comprise: receiving a second transaction request including the payment token, second payment information and the next transaction cryptogram; authenticating the second transaction request based at least in part on the next transaction cryptogram; and providing a second authorization response approval message to authorize the second transaction request. Accordingly, a second transaction may be authorized based on the next transaction cryptogram supplied previously.

The second transaction request may include a third transaction notification identifying a future third transaction. The method may further comprise providing a third cryptogram, or further transaction cryptogram, suitable for use in authenticating a third transaction request. Accordingly, a third cryptogram may be provided following authorization of the second transaction. The second authorization response approval message may comprise the third cryptogram. Further cryptograms may be provided in this way.

Combinations of the two disclosed methods of generating the third cryptogram, and further cryptograms, are envisaged. For example, following authorization of the first transaction, a second and a third cryptogram may be provided. Following authorization of the second transaction, a fourth cryptogram may be provided, and following authorization of the third transaction, fifth and sixth cryptograms may be provided. The provision of further cryptograms is dependent on the respective transaction authorization request including a notification of a future transaction.

The total number of cryptograms may be restricted. For example, the total number of cryptograms may be restricted to three, five, ten, or any other number.

The total number of levels or generations of cryptograms may be restricted. The first cryptogram may be considered to be the first level or generation. Any cryptogram provided following the authorization of the first transaction may be considered to be the second level or generation. Any cryptogram provided following the authorization of a second level or generation transaction may be a third level or generation cryptogram.

The next transaction cryptogram may include a maximum second payment value to limit a value of the second transaction. In this way, a payment up to a predetermined maximum value may be preauthorized, and a requested transaction exceeding the predetermined maximum value may not be authorized or processed. For example, a hotel may charge the room fee with the first transaction, and use the second transaction to charge mini-bar fees that may not be predetermined, but may be capped at a maximum value.

Alternatively, the next transaction cryptogram may include a second payment value. In this way, a second transaction of a predetermined value may be preauthorized. For example, a customer may make an online purchase consisting of two items, one item that is in stock and one item that is out of stock. The first transaction may be used for the item that is in stock and the second transaction may be used for the item that is out of stock. The merchant may retain the next transaction cryptogram until the second item is in stock.

The next transaction cryptogram may include merchant information. The merchant information may be the information of the merchant in the first transaction. Following receipt of a second transaction authorization request, the merchant information in the next transaction cryptogram may be compared to the information of the party submitting the request. The transaction may be refused if the information does not match. In this way, the next transaction cryptogram may be used to process a transaction only by the party submitting the first authorization request, thereby reducing the risk of fraud.

The next transaction cryptogram may include an incrementing transaction counter. The counter may be checked to ensure a sequential numbering of transactions is followed. A transaction request including a cryptogram having a counter value that is greater than or less than expected may be refused. In this way, the security of the further transactions may be improved.

The first cryptogram may include consumer identification information. The next transaction cryptogram may also include the consumer authentication information. In this way, any security or guarantee provided to the consumer, a merchant or any other party by including the consumer identification information in the first cryptogram may also be provided by the next transaction cryptogram. For example, a consumer face scan may be used to authorize the first transaction, and both the first cryptogram and next transaction cryptogram may including information related to said face scan authorization.

The next transaction cryptogram may be time limited. The third and/or any subsequent cryptograms may also be time limited. The time limit may be one week, two weeks, one month, three months, six months, one year or any other desirable time limit. The time limit may be dependent on the type of transaction. In this way, the next transaction or other cryptograms may not be used to authorize a transaction beyond an allowable or agreed time limit.

Each possible merchant-initiated transaction may be codified. Accordingly, the types of merchant-initiated transaction may be sorted into groups or categories. Each group or category may have an accompanying set of rules. The processing of the second transaction, and any subsequent transactions, may take account of the rules related to the group or category to which the type of transaction being processed applies. For example, one group or category may include hotel minibar charges. Said group or category may have a restriction related to a maximum allowed value, and that no further merchant-initiated transactions are permitted. Another group or category may include a recurring subscription. Said group or category may have no restriction to the number of sequential merchant-initiated transactions. A miscellaneous or ‘all others’ category may be provided for otherwise uncategorised transaction types.

According to a second aspect of the present disclosure, there is provided a data processing system comprising a processor configured to perform the method of the first aspect.

According to a third aspect of the present disclosure, there is provided a computer program product comprising instructions which, when the program is executed by a computer, cause the computer to carry out the method of the first aspect.

According to a fourth aspect of the present disclosure, there is provided a computer-readable storage medium comprising instructions which, when executed by a computer, cause the computer to carry out the method of the first aspect. The storage medium may be non-transitory.

### BRIEF DESCRIPTION OF THE DRAWING

FIG. 1 is a flow diagram showing the steps of a multiple payment tokenized digital transaction authentication method; and

FIG. 2 is a flow diagram showing the parties involved, and respective steps taken, in a multiple payment tokenized digital transaction authentication method.

### DETAILED DESCRIPTION

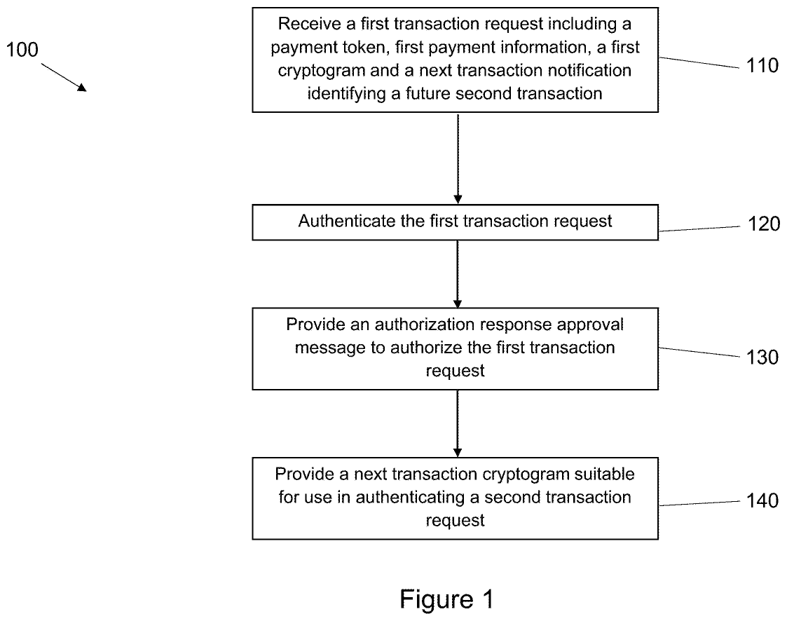

FIG. 1 is a flow diagram showing the steps of a multiple payment tokenized digital transaction authentication method 100.

In a first step, a user may receive 110 a first transaction request. The first transaction request includes a payment token, first payment information, a first cryptogram and a next transaction notification identifying a future second transaction. The payment token may be provided via a digital wallet. The first payment information may include a payment value along with other typical information necessary to complete a transaction. The first cryptogram may be generated by the digital wallet in response to a consumer initiating the first transaction. The second transaction identifier may be used to indicate that a future second transaction may be requested. The second transaction may be merchant-initiated.

The second step is to authenticate 120 the first transaction request. The authentication 120 of the first transaction request may be done via typical processes and is therefore not described in detail. Once the first transaction has been authenticated 120, the next step is to provide 130 an authorization response approval message to authorize the first transaction request. In some circumstances, the first transaction request will be refused and no authorization response approval message will be provided. Following the provision 130 of the authorization response approval message, the first transaction may be processed.

The final step is to provide 140 a next transaction cryptogram suitable for use in authenticating a second transaction request. The next transaction cryptogram may be provided along with, or as part of, the authorization response approval message. The next transaction cryptogram may be provided to, and stored by, a merchant. When the merchant wishes to request a second transaction, the merchant may provide the next transaction cryptogram as part of the request. Accordingly, the second transaction may include the same level of security or protection as the first transaction.

The method 100 may be particularly useful in any scenario in which a merchant may request a merchant-initiated transaction. For example, the first transaction may be used to pay for a hotel room, whilst the second transaction may be used to pay minibar charges. Alternatively, the first transaction and second transaction may be two payments according to a credit agreement. Further transaction requests are envisaged, as described herein.

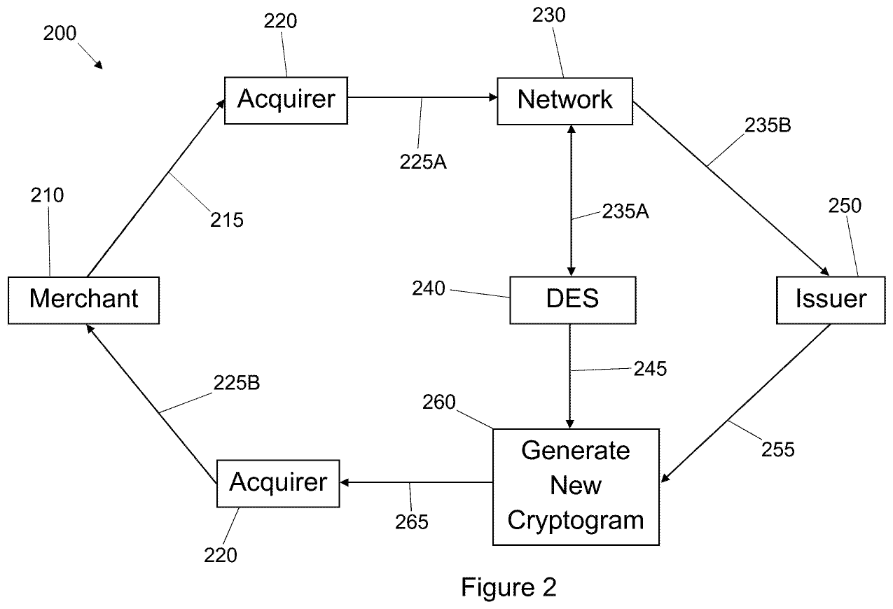

FIG. 2 is a flow diagram showing the parties involved, and respective steps taken, in a multiple payment tokenized digital transaction authentication method.

A consumer, via a merchant 210, may initiate a transaction request 215 including a cryptogram and a notification that a second transaction is intended. The transaction request 215 is passed to an acquirer 220 which may be a bank representing the merchant 210. The acquirer 220 then forwards 225A the transaction details and the cryptogram to a network 230. The information is passed 235A to a digital enablement service (DES) 240, which checks the transaction information and the cryptogram. The information is additionally detokenized and passed 235B to an issuer 250. An issuer may be a bank representing the consumer. The issuer 250 approves or declines the transaction and informs the acquirer 220.

If the transaction is approved by the issuer 250, the approval 255, the decision 245 of the DES 240, and the notification that a second transaction is intended are used to generate a new cryptogram 260 for use in processing a second transaction. Alternatively, the new cryptogram 260 may be generated before the message is passed to the issuer 250. In this way, the new cryptogram 260 may be based on the content of the current transaction cryptogram. Accordingly, the new cryptogram 260 may be generated before the issuer 250 approves or declines the transaction. Should the issuer 250 approve the transaction, the new cryptogram 260 is provided to the acquirer 220. Should the issuer 250 decline the transaction, the new cryptogram 260 may not be provided to the acquirer 220.

The new cryptogram 260 is made available 265 to the acquirer 220. The acquirer 220 can then provide the new cryptogram 260 to the merchant 210. The merchant 210 can store the new cryptogram 260 until the second transaction is requested. In this way, merchant-initiated transactions may cryptographically secured, and consumer card information may not be stored by the merchant 210. Accordingly, the security is increased and the risk of fraud is reduced.

1. A multiple payment tokenized digital transaction authentication method comprising:
receiving a first transaction request including a payment token, first payment information, a first cryptogram and a next transaction notification identifying a future second transaction;
authenticating the first transaction request based at least in part on the first cryptogram;
providing an authorization response approval message to authorize the first transaction request; and
providing a next transaction cryptogram suitable for use in authenticating a second transaction request.

2. The method of claim 1, wherein the first cryptogram is a function of a token number of the payment token and the first payment information.

3. The method of claim 1, wherein the authorization response approval message comprises the next transaction cryptogram.

4. The method of claim 1, wherein the first transaction request relates to a consumer-initiated transaction, and the second transaction relates to a merchant-initiated transaction.

5. The method of claim 1, wherein the first transaction request includes a third transaction notification identifying a future third transaction, and the method further comprises providing a third cryptogram suitable for use in authenticating a third transaction request.

6. The method of claim 1, further comprising:
receiving a second transaction request including the payment token, second payment information and the next transaction cryptogram;
authenticating the second transaction request based at least in part on the next transaction cryptogram; and
providing a second authorization response approval message to authorize the second transaction request.

7. The method of claim 6, wherein the second transaction request includes a third transaction notification identifying a future third transaction, and the method further comprises providing a third cryptogram suitable for use in authenticating a third transaction request.

8. The method of claim 1, wherein the next transaction cryptogram includes a maximum second payment value to limit a value of the second transaction.

9. The method of claim 1, wherein the next transaction cryptogram includes merchant information.

10. The method of claim 1, wherein the next transaction cryptogram includes an incrementing transaction counter.

11. The method of claim 1, wherein the first cryptogram includes consumer identification information and the next transaction cryptogram also includes the consumer identification information.

12. The method of claim 1, wherein the next transaction cryptogram is time limited.

13. A data processing system comprising a processor configured to perform a method comprising:
receiving a first transaction request including a payment token, first payment information, a first cryptogram and a next transaction notification identifying a future second transaction;
authenticating the first transaction request based at least in part on the first cryptogram;
providing an authorization response approval message to authorize the first transaction request; and
providing a next transaction cryptogram suitable for use in authenticating a second transaction request.

14. (canceled)

15. A computer-readable storage medium comprising instructions which, when executed by a computer, cause the computer to:
receive a first transaction request including a payment token, first payment information, a first cryptogram and a next transaction notification identifying a future second transaction;
authenticate the first transaction request based at least in part on the first cryptogram;
provide an authorization response approval message to authorize the first transaction request; and
provide a next transaction cryptogram suitable for use in authenticating a second transaction request.
